(19) United States
(12) Patent Application Publication
(10) Pub. No.: US 2023/0065875 A1
(43) Pub. Date: Mar. 2, 2023

(54) DUST CORE FORMING APPARATUS

(71) Applicant: TOYOTA JIDOSHA KABUSHIKI KAISHA, Toyota-shi (JP)

(72) Inventor: Kohei ISHII, Nagoya-shi (JP)

(73) Assignee: TOYOTA JIDOSHA KABUSHIKI KAISHA, Toyota-shi (JP)

(21) Appl. No.: 17/809,420

(22) Filed: Jun. 28, 2022

(30) Foreign Application Priority Data
Aug. 25, 2021 (JP) 2021-136779

(51) Int. Cl. H01F 41/02; B22F 3/03

(52) U.S. Cl. CPC H01F 41/0246; B22F 3/03; B22F 2003/033

(57) ABSTRACT

An apparatus for forming E-shaped or U-shaped dust cores includes: a die; an upper punch arranged to be insertable and removable into and from the die; a lower punch arranged so as to face the upper punch and to be insertable and removable into and from the die; and a core rod arranged to be insertable and removable into and from the upper punch and the lower punch. The upper punch and the lower punch each has a horizontal cross-sectional shape corresponding to the horizontal cross-sectional shape of two dust cores that are arranged distant from each other with their respective magnetic pole surfaces facing each other. The core rod has a horizontal cross-sectional shape corresponding to the horizontal cross-sectional shape of a hollow part formed between the two dust cores that are arranged distant from each other with their respective magnetic pole surfaces facing each other.

### CROSS REFERENCE TO RELATED APPLICATIONS

This application is based upon and claims the benefit of priority from Japanese patent application No. 2021-136779, filed on Aug. 25, 2021, the disclosure of which is incorporated herein in its entirety by reference.

### BACKGROUND

The present disclosure relates to a dust core forming apparatus for forming E-shaped or U-shaped dust cores.

The technique disclosed in Japanese Unexamined Patent Application Publication No. 2014-084469 is an example of a technique for forming E-shaped or U-shaped dust cores.

In the technique disclosed in Japanese Unexamined Patent Application Publication No. 2014-084469, a die for forming dust cores includes a die, an upper punch, a lower punch, and a core rod, and the core rod is located at the forked parts of the E-shaped or U-shaped dust cores. In order to prevent galling between the core rod and the dust cores, the sliding surface of the core rod with the forked parts of the dust cores is coated with TiN (titanium nitride) or the like.

### SUMMARY

However, as described in Japanese Unexamined Patent Application Publication No. 2014-084469, in a configuration in which a core rod is located at the forked parts of the E-shaped or U-shaped dust cores, the core rod is pushed towards the die side (towards a space into which the punch is released) as the density of the magnetic powder increases at the time of forming the dust cores. Therefore, there is a possibility of galling occurring between the core rod and the die at the time of forming the dust cores or removing the core rod.

The present disclosure has been made in view of the problem mentioned above, and an object of the present disclosure is to provide a dust core forming apparatus for forming dust cores, capable of suppressing occurrence of galling between a core rod and a die.

An aspect of the present disclosure is a dust core forming apparatus for forming E-shaped or U-shaped dust cores, including:

a die;

an upper punch arranged to be insertable and removable along an axial direction of the die into and from the inner side of the die;

a lower punch arranged so as to face the upper punch and to be insertable and removable along the axial direction of the die into and from the inner side of the die; and

a core rod arranged to be insertable and removable along the axial direction of the die into and from the inner side of the upper punch and the lower punch, in which

the upper punch and the lower punch each has a horizontal cross-sectional shape corresponding to the horizontal cross-sectional shape of two dust cores that are arranged distant from each other with their respective magnetic pole surfaces facing each other, and

the core rod has a horizontal cross-sectional shape corresponding to the horizontal cross-sectional shape of a hollow part formed between the two dust cores that are arranged distant from each other with their respective magnetic pole surfaces facing each other.

According to an aspect of the aforementioned disclosure, an effect of being able to provide a dust core forming apparatus for forming dust cores, capable of suppressing occurrence of galling between a core rod and a die can be achieved.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view showing a configuration example of a dust core forming apparatus according to an embodiment of the present disclosure;

FIG. 2 is a cross-sectional diagram showing a configuration example of a dust core forming apparatus according to an embodiment of the present disclosure;

FIG. 3 is a cross-sectional diagram showing an example of a state in which two dust cores are arranged distant from each other with their respective magnetic pole surfaces facing each other; and

FIG. 4 is a cross-sectional diagram showing a configuration example of a dust core forming apparatus according to another embodiment of the present disclosure.

### DESCRIPTION OF EMBODIMENTS

Hereinbelow, the present disclosure will be described with reference to the embodiments of the present disclosure. However, the present disclosure is not to be limited to the embodiments described below. Further, not all of the components/structures described in the embodiments are necessarily indispensable as means for solving the problem.

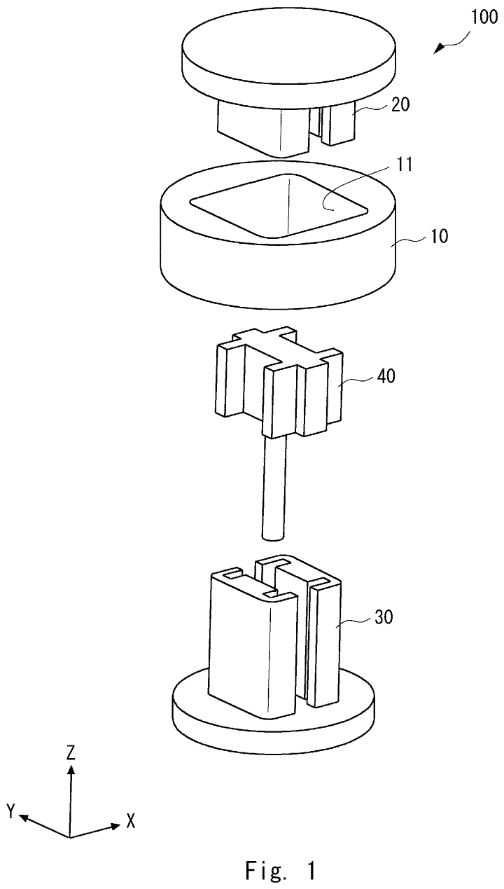

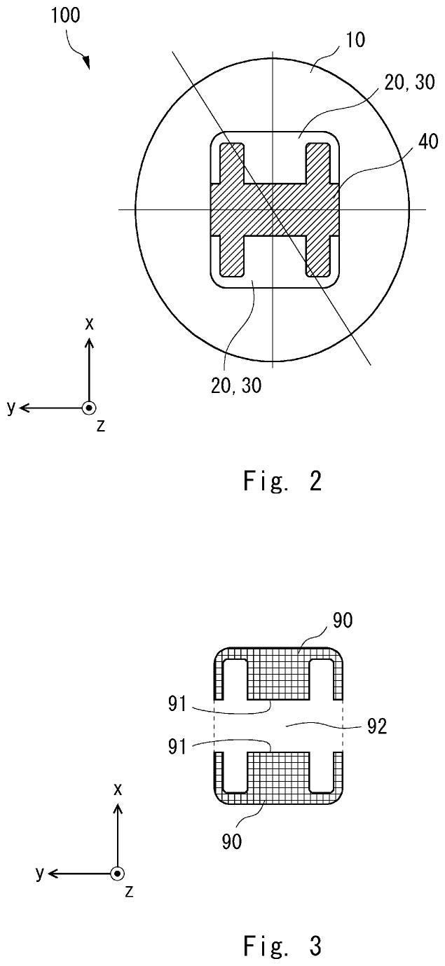

FIGS. 1 and 2 are diagrams showing a configuration example of a forming apparatus 100 for forming dust cores 90 according to the present embodiment. FIG. 1 is a perspective view and FIG. 2 is a cross-sectional diagram. Note that FIGS. 1 and 2 show an example of the forming apparatus 100 for forming E-shaped dust cores 90.

Referring to FIGS. 1 and 2, the forming apparatus 100 according to the present embodiment includes a die 10, an upper punch 20, a lower punch 30, and a core rod 40. Note that in FIGS. 1 and 2, of the overall configuration of the forming apparatus 100 according to the present embodiment, only the configuration of a die for forming the dust cores is shown, and other configurations (for example, a press mechanism for elevating and lowering each part of the forming apparatus 100 when forming the dust cores 90) are omitted.

The die 10 has an opening 11 formed on the inner side thereof.

The upper punch 20 is arranged to be insertable and removable along the axial direction of the die 10 into and from the opening 11 formed on the inner side of the die 10.

The lower punch 30 is arranged so as to face the upper punch 20 and to be insertable and removable along the axial direction of the die 10 into and from the opening 11 formed on the inner side of the die 10.

The core rod 40 is arranged to be insertable and removable along the axial direction of the die 10 into and from the upper punch 20 and the lower punch 30.

FIG. 3 is a cross-sectional diagram showing an example of a state in which two E-shaped dust cores 90 are arranged distant from each other with their respective magnetic pole surfaces 91 facing each other.

Referring to FIG. 2, in the forming apparatus 100 according to the present embodiment, the upper punch 20 and the lower punch 30 each has a horizontal cross-sectional shape corresponding to the cross-sectional shape of the two dust cores 90 that are arranged as shown in FIG. 3. That is, the upper punch 20 and the lower punch 30 each has a horizontal cross-sectional shape corresponding to the horizontal cross-sectional shape of the two dust cores 90 that are arranged distant from each other with their respective magnetic pole surfaces 91 facing each other.

Further, the core rod 40 has a horizontal cross-sectional shape corresponding to the horizontal cross-sectional shape of a hollow part 92 formed between the two dust cores 90 arranged as shown in FIG. 3. That is, the core rod 40 has a horizontal cross-sectional shape corresponding to the horizontal cross-sectional shape of the hollow part 92 formed between the two dust cores 90 that are arranged distant from each other with their respective magnetic pole surfaces 91 facing each other.

Therefore, when forming the dust cores 90, two dust cores 90 are formed simultaneously under a state in which the two dust cores 90 are arranged distant from each other with their respective magnetic pole surfaces 91 facing each other and the core rod 40 is disposed between the two dust cores 90.

To be more specific, a method of forming the dust cores 90 with the forming apparatus 100 according to the present embodiment is as follows.

When forming the dust cores 90, the lower punch 30 is inserted into the die 10 so as to block the opening 11 of the die 10 from the bottom thereof. Further, the core rod 40 is inserted into the lower punch 30. In this state, the die 10 is filled from the opening 11 thereof with the magnetic powder that is the material of the dust cores 90. Then, by compressing the magnetic powder from above using the upper punch 20, the two dust cores 90 are formed simultaneously.

After forming the dust cores 90, the die 10 is pulled downward while a load is applied to the two dust cores 90 using the upper punch 20 and the lower punch 30, and then the two dust cores 90 are taken out from the die 10. Then, the load that is being applied to the dust cores 90 by the upper punch 20 and the lower punch 30 is released. As a result, the stress applied to the core rod 40 disposed between the two dust cores 90 is eliminated and thus the core rod 40 descends.

Here, in the present embodiment, like in the technique disclosed in Japanese Unexamined Patent Application Publication No. 2014-084469, the core rod 40 is pushed towards a space into which the upper punch 20 or the lower punch 30 is released as the density of the magnetic powder increases at the time of forming the dust cores 90.

However, in the present embodiment, the upper punch 20 and the lower punch 30 each has a horizontal cross-sectional shape corresponding to the horizontal cross-sectional shape of the two dust cores 90 that are arranged distant from each other with their respective magnetic pole surfaces 91 facing each other. Further, the core rod 40 has a horizontal cross-sectional shape corresponding to the horizontal cross-sectional shape of a hollow part 92 formed between the two dust cores 90 that are arranged distant from each other with their respective magnetic pole surfaces 91 facing each other.

Therefore, in the present embodiment, since the core rod 40 is to be disposed between the two dust cores 90 that are arranged with their magnetic pole surfaces 91 facing each other, the core rod 40 will not be pushed towards the die 10 side. Therefore, it is possible to suppress occurrence of galling between the core rod 40 and the die 10 at the time of forming the dust cores or removing the core rod 40. Further, since it is possible to suppress occurrence of galling between the core rod 40 and the die 10, it is possible to reduce damage to the die for forming the dust cores.

Further, in the present embodiment, since the two dust cores 90 can be formed simultaneously, it is possible to improve the productivity of the dust cores 90.

Note that the present disclosure is not to be limited to the embodiments described above and can be modified as appropriate without departing from the gist of the present disclosure.

For instance, the aforementioned embodiments have been described with reference to an example of forming E-shaped dust cores 90 but the present disclosure is not limited to formation of the E-shaped dust cores 90.

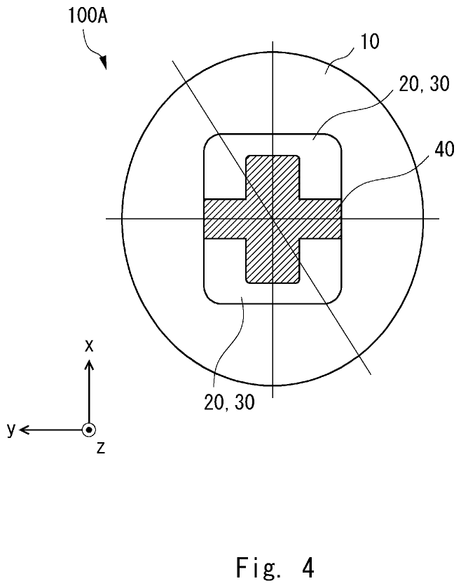

The present disclosure is applicable to formation of two dust cores 90 each having a magnetic pole surface 91 and having such a shape that the dust cores can be arranged with their magnetic pole surfaces 91 facing each other. An example of such dust cores 90 is the U-shaped dust cores 90. FIG. 4 is a cross-sectional diagram showing an example of the forming apparatus 100A for forming the U-shaped dust cores 90.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A dust core forming apparatus for forming E-shaped or U-shaped dust cores, comprising:
a die;
an upper punch arranged to be insertable and removable along an axial direction of the die into and from the inner side of the die;
a lower punch arranged so as to face the upper punch and to be insertable and removable along the axial direction of the die into and from the inner side of the die; and
a core rod arranged to be insertable and removable along the axial direction of the die into and from the inner side of the upper punch and the lower punch, wherein
the upper punch and the lower punch each has a horizontal cross-sectional shape corresponding to the horizontal cross-sectional shape of two dust cores that are arranged distant from each other with their respective magnetic pole surfaces facing each other, and
the core rod has a horizontal cross-sectional shape corresponding to the horizontal cross-sectional shape of a hollow part formed between the two dust cores that are arranged distant from each other with their respective magnetic pole surfaces facing each other.

2. The dust core forming apparatus according to claim 1, wherein the two dust cores are simultaneously formed under a state in which the two dust cores are arranged distant from each other with their respective magnetic pole surfaces facing each other and the core rod is disposed between the two dust cores.
